(19) United States
(12) Patent Application Publication
(10) Pub. No.: US 2024/0316667 A1
(43) Pub. Date: Sep. 26, 2024

(54) ALUMINUM ALLOY BRAZING SHEET AND METHOD FOR MANUFACTURING THE SAME

(71) Applicant: UACJ Corporation, Tokyo (JP)

(72) Inventors: Tatsuya Ide, Tokyo (JP); Yutaka Yanagawa, Tokyo (JP); Makoto Ando, Tokyo (JP); Takashi Urahama, Kariya-shi, Aichi (JP); Toshihide Ninagawa, Kariya-shi, Aichi (JP)

(73) Assignee: UACJ Corporation, Tokyo (JP)

(21) Appl. No.: 18/693,701

(22) PCT Filed: Aug. 9, 2022
(86) PCT No.: PCT/JP2022/030355

§ 371 Date: Mar. 20, 2024

(30) Foreign Application Priority Data
Sep. 21, 2021 (JP) 2021-153199

(51) Int. Cl. B23K 1/19; B23K 35/28; C22F 1/043; C22F 1/047

(52) U.S. Cl. CPC B23K 1/19; B23K 35/286; C22F 1/043; C22F 1/047

(57) ABSTRACT

Provided is a brazing sheet that can exhibit excellent brazability in brazing an aluminum material without using flux in an inert gas atmosphere such as nitrogen gas atmosphere. An aluminum alloy brazing sheet to be used for brazing in an inert gas atmosphere is an aluminum alloy brazing sheet comprising: a core material; and a brazing material clad on one side or both sides of the core material, wherein the core material is made of an aluminum alloy comprising Mg at 0.10 to 0.50 mass % with the balance being aluminum and inevitable impurities, the brazing material is made of an aluminum alloy comprising Si at 6.00 to 13.00 mass % and Mg at a content limited to less than 0.05 mass % with the balance being aluminum and inevitable impurities, and a Mg integration value from a surface of the brazing material to a depth of 30 nm is 150 atm %×nm or less.

### TECHNICAL FIELD

The present invention relates to an aluminum alloy brazing sheet and a method for manufacturing the same.

### BACKGROUND ART

Aluminum products, such as heat exchangers and mechanical parts made of aluminum, each include many parts made of aluminum materials (including aluminum and aluminum alloys. The same applies hereinafter.).

These aluminum products have many small joints, and joining by brazing is widely used as a joining method to form such joints. Many of these aluminum products are brazed with what is called brazing sheets, which are aluminum materials each including a core material and a brazing material provided on at least one side of the core material.

In order to join aluminum materials (including aluminum alloy materials) by brazing, a method of, while breaking an oxide film covering the surface of a brazing material, bringing the molten brazing material into contact with an opposing material to be joined and breaking an oxide film covering the surface of the opposing material during brazing is required. This method is broadly divided into a method using flux (flux brazing method) and a method of heating in a vacuum (vacuum brazing method), which are in practical use.

Among these methods, the flux brazing method is a method in which flux is applied to the surface of a joining target portion, i.e., a portion to be joined by brazing, and brazing is performed.

However, the flux brazing method requires operation of applying flux before brazing and also operation of removing the flux and its residue after the brazing is completed, which increases the manufacturing cost of aluminum products. If the flux and its residue cannot be sufficiently removed after the brazing is completed, there may be a situation in which sufficient surface quality is not obtained when surface treatment or the like is subsequently performed.

By contrast, the vacuum brazing method is a method of brazing in a vacuum without applying flux to the surface of a joining target portion.

However, the vacuum brazing method is less productive than the flux brazing method, and it is difficult to obtain sufficient brazing quality. In addition, brazing furnaces used for the vacuum brazing method are more likely to require higher equipment and maintenance costs than general brazing furnaces.

In view of this, what is called a flux-free brazing method, in which brazing is performed in an inert gas atmosphere without applying flux to the surface of a joining target portion, has been proposed. A brazing sheet to be used in the flux-free brazing method contains an element having the effect of weakening an oxide film or breaking the oxide film in at least one layer of a laminated structure, and Mg is often used as an element of this type.

However, Mg is relatively easily oxidized, and the Mg in a brazing material surface layer reacts with oxygen that enters from the outside, thereby easily forming a MgO film.

This MgO film is much stronger than an Al₂O₃ film, and thus for a brazing sheet on which the MgO film has grown to be thickly formed, it is difficult to exhibit good brazability because the MgO film is not broken during brazing and the molten brazing material is less likely to get wet and spread over the surface.

In other words, even when the Al₂O₃ film on the surface of the brazing sheet is thin in thickness, brazing failure is more likely to occur if the MgO film is thick.

Under these circumstances, Patent Literature 1 proposes an aluminum alloy brazing sheet to be used for brazing in an inert gas atmosphere without using flux, the aluminum alloy brazing sheet comprising: a core material made of aluminum or an aluminum alloy; and a brazing material of an aluminum alloy comprising Si at 4.0 to 13.0 mass % clad on one side or both sides of the core material, in which oxide particles comprising X atoms are formed on the surface by heating for brazing and the volume change ratio of the X atoms to an oxide film before the heating for brazing is 0.99 or less.

Patent Literature 2 discloses a method of brazing an aluminum material without using flux, the method wherein a brazing sheet made of an Al—Si—Mg-based brazing material comprising Si: 5.0 to 13.0 mass % and Mg: 0.1 to 3.0 mass %, which has been clad on a core material and is located on its uppermost surface, is used, the average film thickness of an oxide film on the surface of the Al—Si—Mg-based brazing material before brazing is 150 Å or less and the average film thickness of a magnesium oxide film in the oxide film is 20 Å or less, and in a non-oxidizing atmosphere with an oxygen concentration of 50 ppm or less without reducing pressure, the Al—Si—Mg-based brazing material in the brazing sheet and a member to be brazed are brought into intimate contact with each other, whereby the core material and the member to be brazed are joined by brazing with the Al—Si—Mg-based brazing material without using flux in this contact portion.

### CITATION LIST

### Patent Literature

Patent Literature 1: Japanese Patent Publication 2019-069474-A
Patent Literature 2: Japanese Patent Publication 2013-215797-A

### SUMMARY OF INVENTION

### Technical Problem

However, as a result of studies made by the inventors of the present invention, it was found that the brazing sheet described in Patent Literature 1 cannot sufficiently break the oxide film on the surface of the brazing material when it becomes thicker, the molten brazing material does not sufficiently get wet and spread over the surface, and consequently a desired newly formed surface cannot be exposed and brazing failure easily occurs.

Although the Patent Literature 1 states that the oxide film on the brazing material surface can be easily broken by reducing the thickness of the oxide film to 30 nm or less, the tendency of the oxide film to break easily varies depending on elements that constitute the oxide film, and thus simply controlling the thickness of the oxide film does not necessarily prevent the occurrence of brazing failure.

Furthermore, as a result of studies made by the inventors, it was found that, in the brazing sheet described in Patent Literature 2, even though the MgO film before heating for brazing is thin in thickness, the MgO film forms and grows during the heating for brazing because Mg is contained in the brazing material.

In other words, it was found that, on the brazing sheet described in Patent Literature 2, a thick oxide film has already been formed when the brazing material melts, and accordingly the oxide film is not broken and the molten brazing material cannot get wet and spread over the surface, resulting in poor brazability.

Under these circumstances, it is an object of the present invention to provide a brazing sheet that can exhibit excellent brazability when an aluminum material is brazed without using flux in an inert gas atmosphere such as nitrogen gas atmosphere and a method for manufacturing the same.

### Solution to Problem

As a result of repeated diligent studies in order to solve the above-mentioned technical problems, the inventors found that the technical problems can be solved by an aluminum alloy brazing sheet to be used for brazing in an inert gas atmosphere, the aluminum alloy brazing sheet comprising: a core material; and a brazing material clad on one side or both sides of the core material, in which the core material is made of an aluminum alloy comprising Mg at 0.10 to 0.50 mass % with the balance being aluminum and inevitable impurities, the brazing material is made of an aluminum alloy comprising Si at 6.00 to 13.00 mass % and Mg at a content limited to less than 0.05 mass % with the balance being aluminum and inevitable impurities, and a Mg integration value from a surface of the brazing material to a depth of 30 nm is 150 atm %×nm or less. Thus, the inventors have completed the present invention based on this knowledge.

In other words, the present inventions are
(1) An aluminum alloy brazing sheet to be used for brazing in an inert gas atmosphere, the aluminum alloy brazing sheet comprising:
   a core material; and
   a brazing material clad on one side or both sides of the core material, wherein
   the core material is made of an aluminum alloy comprising Mg at 0.10 to 0.50 mass % with the balance being aluminum and inevitable impurities,
   the brazing material is made of an aluminum alloy comprising Si at 6.00 to 13.00 mass % and Mg at a content limited to less than 0.05 mass % with the balance being aluminum and inevitable impurities, and
   a Mg integration value from a surface of the brazing material to a depth of 30 nm is 150 atm %×nm or less;
(2) The aluminum alloy brazing sheet according to (1), wherein the brazing material further comprises Bi at 1.00 mass % or less;
(3) The aluminum alloy brazing sheet according to (1) or (2), wherein the core material further comprises one type or two or more types of: Fe at 0.70 mass % or less; Si at 0.70 mass % or less; Mn at 1.60 mass % or less; and Cu at 0.50 mass % or less;
(4) The aluminum alloy brazing sheet according to any one of (1) to (3), wherein the core material further comprises Zn at 3.00 mass % or less;
(5) The aluminum alloy brazing sheet according to any one of (1) to (4), wherein the surface is etched with acid;
(6) A method for manufacturing the aluminum alloy brazing sheet according to any one of (1) to (5), wherein
   in manufacturing the aluminum alloy brazing sheet by subjecting a laminate comprising a core-material ingot and a brazing-material ingot laminated on one side or both sides of the core-material ingot to at least hot working, cold working, and one or more annealings selected from one or more intermediate annealings between passes of rolling in the cold working and final annealing after a last pass of the cold working, heating during the one or more annealings selected from the intermediate annealings between the passes of the cold rolling and the final annealing after the last pass of the cold working is performed such that a value of a diffusion area D expressed by Formula (I) below becomes 7.0×10⁻¹⁰ m² or less,

$$D = Σ {D}_{0} \cdot exp ( - Q / ( RTn ) ) \cdot Δ tn \qquad ( I )$$

(in Formula, Tn is a heating temperature (K) at each infinitesimal time when a total heating time (in seconds) in the intermediate annealings and the final annealing is divided by an infinitesimal time Δtn (in seconds), D₀=1.24×10⁻⁴ (m²/s), Q=130 (kJ/mol), and R=8.3145 (J/(mol·K));
(7) The method for manufacturing the aluminum alloy brazing sheet according to (6), wherein the intermediate annealings or the final annealing is performed with the brazing-material ingot being rolled to a thickness of 10 μm to 50 μm.

### Advantageous Effect of Invention

According to the present invention, it is possible to provide a brazing sheet having excellent brazability in brazing an aluminum material without using flux in an inert gas atmosphere such as nitrogen gas atmosphere, and a method for manufacturing the same.

### BRIEF DESCRIPTION OF DRAWINGS

FIG. 1(a) is a graph illustrating a relation of Mg concentration versus the distance (μm) from a surface of a brazing material forming an aluminum alloy brazing sheet, and FIG. 1(b) is a partially enlarged graph of a portion indicated by the dashed line in FIG. 1(a).

FIG. 2 is an explanatory schematic diagram of a mini-core specimen prepared in Examples and Comparative Example of the present application.

### DESCRIPTION OF EMBODIMENTS

An aluminum alloy brazing sheet according to the present invention is an aluminum alloy brazing sheet to be used for brazing in an inert gas atmosphere, the aluminum alloy brazing sheet comprising:
a core material; and
a brazing material clad on one side or both sides of the core material, wherein
the core material is made of an aluminum alloy comprising Mg at 0.10 to 0.50 mass % with the balance being aluminum and inevitable impurities,
the brazing material is made of an aluminum alloy comprising Si at 6.00 to 13.00 mass % and Mg at a content limited to less than 0.05 mass % with the balance being aluminum and inevitable impurities, and
a Mg integration value from a surface of the brazing material to a depth of 30 nm is 150 atm %×nm or less.

To begin with, the aluminum alloy brazing sheet according to the present invention will be described.

The aluminum alloy brazing sheet according to the present invention comprises a core material and a brazing material clad to one side (either one main surface) or both sides (both main surfaces) of the core material.

In the aluminum alloy brazing sheet according to the present invention, the core material is made of an aluminum alloy comprising Mg at 0.10 to 0.50 mass % with the balance being aluminum and inevitable impurities.

In the aluminum alloy brazing sheet according to the present invention, the core material comprises Mg.

Mg comprised in the core material gradually diffuses into the brazing material during heating for brazing, and at the same time as the brazing material begins to melt (specifically, Al—Si—Mg ternary eutectic partially melts), it diffuses rapidly toward the surface of the brazing material and easily weakens an oxide film of aluminum covering the surface of the brazing material, thereby being able to break this oxide film.

Most of this Mg is supplied from the core material rather than the brazing material, and thus it is possible to easily weaken the oxide film of aluminum covering the brazing material surface while suppressing the formation of MgO on the brazing material surface.

Mg also dissolves into the matrix in a solid state to increase material strength by solid-solution strengthening.

The Mg content in the core material is 0.10 to 0.50 mass %, preferably 0.10 to 0.45 mass %, and more preferably 0.15 to 0.40 mass %.

When the Mg content in the core material is within these ranges, a sufficient amount of Mg can diffuse and elute into the brazing material to weaken the oxide film of aluminum on the brazing material surface, and also can suppress decrease in solidus temperature (melting point) of the core material to prevent melting of the core material during brazing.

In the aluminum alloy brazing sheet according to the present invention, the core material may comprise Fe.

When the core material comprises Fe, the Fe content in the core material is preferably 0.70 mass % or less, more preferably 0.05 to 0.50 mass %, and even more preferably 0.10 to 0.40 mass %.

When the Fe content in the core material is 0.70 mass % or less, it is possible to form an intermetallic compound with another metallic element to easily exert a desired strength-enhancing effect while easily suppressing decrease in corrosion resistance and formation of a coarse crystallized substance.

In the aluminum alloy brazing sheet of the present invention, the core material may comprise Si.

When the core material comprises Si, the Si content in the core material is preferably 0.70 mass % or less, more preferably 0.10 to 0.65 mass %, and even more preferably 0.20 to 0.60 mass %.

When the Si content in the core material is within these ranges, it is possible to easily increase the strength of the core material by solid-solution strengthening and fine-precipitation strengthening of intermetallic compounds while easily suppressing local melting caused by decrease in the melting point of the core material.

In the aluminum alloy brazing sheet according to the present invention, the core material may comprise Mn.

When the core material comprises Mn, the Mn content in the core material is preferably 1.60 mass % or less, more preferably 0.40 to 1.60 mass %, and even more preferably 0.60 to 1.50 mass %.

When the Mn content in the core material is within these ranges, it is possible to easily increase the strength of the core material and easily increase the corrosion resistance of the core material by adjusting the electric potential thereof, while easily suppressing decrease in rolling workability caused by the formation of a coarse crystallized substance during casting.

In the aluminum alloy brazing sheet according to the present invention, the core material may comprise Cu.

When the core material comprises Cu, the Cu content in the core material is preferably 0.50 mass % or less, more preferably 0.05 to 0.45 mass %, and even more preferably 0.10 to 0.40 mass %.

When the Cu content in the core material is within these ranges, it is possible to easily increase the corrosion resistance of the core material by adjusting the electric potential thereof, while suppressing local melting caused by decrease in the melting point of the core material and easily increasing the strength of the core material.

In the aluminum alloy brazing sheet according to the present invention, the core material may comprise Zn.

When the core material comprises Zn, the Zn content in the core material is preferably 3.00 mass % or less, more preferably 0.50 to 2.50 mass %, and even more preferably 1.00 to 2.00 mass %.

When the Zn content in the core material is within these ranges, it is possible to easily allow the core material to function as a sacrificial anode for a long period of time by setting the natural potential of the core material less-noble.

In the aluminum alloy brazing sheet according to the present invention, the core material may comprise Ti.

When the core material comprises Ti, the Ti content in the core material is preferably 0.20 mass % or less, more preferably 0.05 to 0.20 mass %, and even more preferably 0.05 to 0.18 mass %.

When the Ti content in the core material is within these ranges, it is possible to easily suppress development of corrosion of the core material in the depth direction by allowing the corrosion to develop in a layered manner.

In the aluminum alloy brazing sheet according to the present invention, the core material may comprise Zr.

When the core material comprises Zr, the Zr content in the core material is preferably 0.50 mass % or less, more preferably 0.05 to 0.30 mass %, and even more preferably 0.10 to 0.20 mass %.

When the content of Zr in the core material is within these ranges, it is possible to easily suppress development of corrosion of the core material in the depth direction by allowing the corrosion to develop in a layered manner.

In the aluminum alloy brazing sheet according to the present invention, the core material may comprise Cr.

When the core material comprises Cr, the Cr content in the core material is preferably 0.50 mass % or less, more preferably 0.05 to 0.30 mass %, and even more preferably 0.10 to 0.20 mass %.

When the Cr content in the core material is within these ranges, it is possible to easily suppress development of corrosion of the core material in the depth direction by allowing the corrosion to develop in a layered manner.

In the aluminum alloy brazing sheet according to the present invention, the core material may comprise V.

When the core material comprises V, the V content in the core material is preferably 0.50 mass % or less, more preferably 0.05 to 0.30 mass %, and even more preferably 0.10 to 0.20 mass %.

When the content of V in the core material within these ranges, it is possible to easily suppress development of corrosion of the core material in the depth direction by allowing the corrosion to develop in a layered manner.

In the present application document, the contents of the respective components constituting the core material mean values measured by an emission spectrophotometer.

In the aluminum alloy brazing sheet according to the present invention, the brazing material is clad on one side or both sides of the core material, and the brazing material is made of an aluminum alloy comprising Si at 6.00 to 13.00 mass % and Mg at a content limited to less than 0.05 mass % with the balance being aluminum and inevitable impurities.

In the aluminum alloy brazing sheet according to the present invention, the brazing material comprises Si.

Si comprised in the brazing material lowers the melting point of Al and increases its fluidity, thereby exerting the function of the brazing material.

The Si content in the brazing material is 6.00 to 13.00 mass %, preferably 6.70 to 12.80 mass %, and more preferably 9.00 to 12.50 mass %.

When the Si content in the brazing material is within these ranges, sufficient fluidity can be achieved and erosion to the core material or other portions to be joined can be suppressed.

In the aluminum alloy brazing sheet according to the present invention, the Mg content in the brazing material is limited to less than 0.05 mass %.

Mg comprised in the brazing material can easily weaken and break the oxide film of aluminum covering the surface of the brazing material during heating for brazing. However, in the present application document, the Mg content in the brazing material is limited in order to suppress formation of a MgO film on the brazing material surface.

The Mg content in the brazing material is less than 0.05 mass % (0.00 mass % or more and less than 0.05 mass %), preferably 0.00 to 0.04 mass %, and more preferably 0.00 to 0.02 mass %.

When the Mg content in the brazing material is less than 0.05 mass %, while the formation of MgO on the brazing material surface is suppressed, a sufficient amount of Mg can diffuse and elute from the core material into the brazing material during brazing to weaken the aluminum oxide film on the brazing material surface.

In the aluminum alloy brazing sheet according to the present invention, the brazing material may comprise Bi.

The Bi content in the brazing material is preferably 1.00 mass % or less, more preferably 0.005 to 1.00 mass %, even more preferably 0.01 to 0.40 mass %, further preferably 0.010 to 0.20 mass %, and even further preferably 0.01 to 0.10 mass %.

When the Bi content in the brazing material is within these ranges, it is possible to lower the surface tension of the brazing material and easily increase the fluidity of the brazing material.

In the aluminum alloy brazing sheet according to the present invention, the brazing material may comprise one or two types selected from Sr and Na.

The Sr content in the brazing material is preferably 0.100 mass % or less, more preferably 0.070 mass % or less, and even more preferably 0.050 mass % or less.

The lower limit of the Sr content in the brazing material is preferably, but not limited to, 0.003 mass % or more.

The Na content in the brazing material is preferably 0.300 mass % or less, more preferably 0.200 mass % or less, and even more preferably 0.100 mass % or less.

The lower limit of the Na content in the brazing material is preferably, but not limited to, 0.002 mass % or more.

When the contents of Sr and Na are within these respective ranges, it is possible to achieve a finer structure of the solidified brazing material in a joint formed after brazing and suitably increase the joining strength.

The total content of Sr and Na in the brazing material is preferably 0.002 to 0.600 mass %, more preferably 0.003 to 0.400 mass %, and even more preferably 0.005 to 0.200 mass %.

In the present application document, the contents of the respective components constituting the brazing material can be measured by an emission spectrophotometer.

In the aluminum alloy brazing sheet according to the present invention, a Mg integration value from the brazing material surface to a depth of 30 nm is 150 atm %× nm or less, preferably 110 atm %×nm or less, and more preferably 70 atm %×nm or less.

In the aluminum alloy brazing sheet according to the present invention, when the Mg integration value from the brazing material surface to a depth of 30 nm is 150 atm %×nm or less, the thickness of the MgO film on the brazing material surface is controlled to be a predetermined thickness, which allows this MgO film to be easily broken during brazing and allows the molten brazing material to get wet and spread over the surface, whereby excellent brazability can be easily obtained.

In the present application document, the Mg integration value from the brazing material surface to a depth of 30 nm means an integrated value of Mg concentration to a depth of 30 nm when the operation of sputtering the brazing material surface with argon ions and measuring the Mg concentration is repeated every 1 nm in depth using an X-ray photoelectron spectrometer (XPS).

The Mg concentration at each 1 nm depth is determined from the sputtering rate (sputtering depth/sputtering time) and sputtering time during measurement with the XPS, and this sputtering rate (sputtering depth/sputtering time) is calculated based on the time it takes for the measured value of the O concentration to reach zero when the O concentration is measured while a SiO₂ thin film having a known thickness is being sputtered.

According to studies of the inventors, the process of formation and growth of a MgO film during heating for brazing was diligently examined, and the following findings were obtained.

In other words, when a brazing sheet clad with a brazing material having a limited Mg content is heated for brazing with respect to a core material comprising Mg at a predetermined content, Mg diffuses from the core material into the brazing material and reacts with oxygen in the atmosphere to form MgO when it reaches the brazing material surface from inside the brazing material.

This reduces the metal Mg concentration near the brazing material surface, which increases the difference in metal Mg concentration between the inside and the surface of the brazing material, thereby allowing metal Mg inside the brazing material to easily move to the vicinity of the brazing material surface.

When the metallic Mg has reached the vicinity of the brazing material surface, it further reacts with oxygen in the atmosphere to form MgO, whereby a Mg-enriched layer is formed in the very surface layer up to a depth of 30 nm from the brazing material surface.

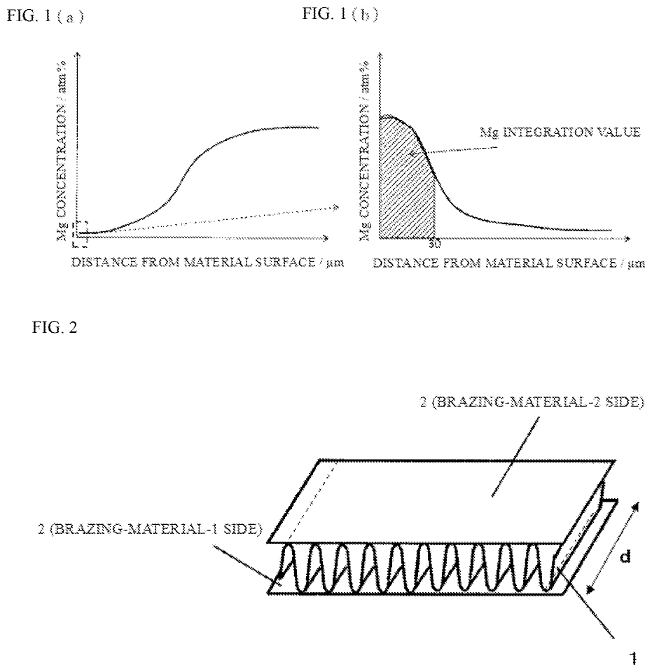

FIG. 1(a) is a graph illustrating a relation of Mg concentration versus the distance (μm) from a surface of a brazing material forming the aluminum alloy brazing sheet, and FIG. 1(b) is a partially enlarged graph of a portion indicated by the dashed line in FIG. 1(a).

Even in the aluminum alloy brazing sheet having a limited Mg content near the surface (at a distance of 0 μm from the material surface) as illustrated in FIG. 1(a), it can be seen that a Mg-enriched layer having a high Mg concentration is formed in the very surface layer from the brazing material surface to a depth of 30 nm as illustrated in FIG. 1(b).

The inventors found that, by using such an aluminum alloy brazing sheet that is a brazing sheet clad with a brazing material having a limited Mg content with respect to a core material comprising Mg at a predetermined content and in which the Mg integration value in the Mg-enriched layer on the brazing material surface is controlled to be a predetermined value or less in advance, suitable brazing can be achieved by easily weakening an aluminum oxide film and a MgO film during brazing while controlling the thickness of the MgO film on the brazing material surface during brazing. Thus, the inventors have completed the present invention.

The aluminum alloy brazing sheet according to the present invention has a core material and a brazing material clad on one side or both sides of the core material.

The aluminum alloy brazing sheet according to the present invention can take: (1) a form of a two-layer material in which the brazing material is clad on only one side of the core material (core material/brazing material); (2) a form of a three-layer material in which the brazing material is clad on both sides of the core material (brazing material/core material/brazing material); and (3) a form of a three-layer material in which the brazing material is clad on one side of the core material and a sacrificial anode material is clad on the other side (brazing material/core material/sacrificial anode material).

In the aluminum alloy brazing sheet according to the present invention, the clad ratio (the ratio of the thickness of the brazing material to the thickness of the aluminum alloy brazing sheet) of the brazing material clad on one side or both sides of the core material is preferably 3 to 30%, more preferably 5 to 25%, and even more preferably 7 to 20%.

When the aluminum alloy brazing sheet according to the present invention takes (2) the form of a three-layer material in which the brazing material is clad on both sides of the core material, the compositions and the clad ratios of the brazing materials formed on both sides of the core material may be the same or different.

When the aluminum alloy brazing sheet according to the present invention takes (3) the form of a three-layer material in which the brazing material is clad on one side of the core material and a sacrificial anode material is clad on the other side, the sacrificial anode material is preferably made of aluminum or made of an aluminum alloy comprising Zn at 8.00 mass % or less and the balance being aluminum and inevitable impurities.

The purity of aluminum forming this sacrificial anode material is preferably, but not limited to, 99.0 mass % or more, and more preferably 99.5 mass % or more.

The aluminum alloy for the sacrificial anode material preferably comprises Zn. The Zn comprised in the sacrificial anode material has an effect of setting the potential less-noble, which exerts a sacrificial anti-corrosion effect when a potential difference is formed between the sacrificial anode material and the core material. The Zn content in the sacrificial anode material is preferably 8.00 mass % or less, and more preferably 3.00 mass % or less.

In the aluminum alloy brazing sheet according to the present invention, this sacrificial anode material may comprise Fe.

When the sacrificial anode material comprises Fe, the Fe content in the sacrificial anode material is preferably 1.00 mass % or less, more preferably 0.05 to 0.80 mass %, and even more preferably 0.100 to 0.700 mass %.

When the content of Fe in the sacrificial anode material is within these ranges, the strength can be easily increased, and also deformation resistance during hot rolling increases, whereby the difference in deformation resistance from the core material can be reduced.

In the aluminum alloy brazing sheet according to the present invention, the sacrificial anode material may comprise Mn.

When the sacrificial anode material comprises Mn, the Mn content in the sacrificial anode material is preferably 1.80 mass % or less, more preferably 0.10 to 1.50 mass %, and even more preferably 0.20 to 1.20 mass %.

When the Mn content in the sacrificial anode material is within these ranges, the size of grains of the sacrificial anode material formed by recrystallization during brazing can be adjusted.

In the aluminum alloy brazing sheet according to the present invention, the sacrificial anode material may comprise Mg.

When the sacrificial anode material comprises Mg, the Mg content in the sacrificial anode material is preferably 1.00 mass % or less, more preferably 0.05 to 1.00 mass %, and even more preferably 0.10 to 0.80 mass %.

When the Mg content in the sacrificial anode material within these ranges, the strength of the sacrificial anode material can be easily increased.

In the present application document, the contents of the respective components constituting the sacrificial anode material mean values measured by an emission spectrophotometer (XPS).

In the aluminum alloy brazing sheet according to the present invention, the clad ratio of the sacrificial anode material (the ratio of the thickness of the sacrificial anode material to the thickness of the aluminum alloy brazing sheet) is preferably 3 to 30%, more preferably 5 to 25%, and even more preferably 7 to 20%.

The aluminum alloy brazing sheet according to the present invention is used as a forming material for, for example, fins that serve as heat-transfer media in heat exchangers, tubes that serve as channel-forming members through which refrigerants and other materials flow, and plates that are joined with tubes to form the structure of heat exchangers.

When the aluminum alloy brazing sheet according to the present invention is used for fin materials, the thickness of the brazing sheet is preferably about 0.04 to 0.20 mm. When the aluminum alloy brazing sheet according to the present invention is used for tube materials, the thickness of the brazing sheet is preferably about 0.15 to 0.50 mm.

When the aluminum alloy brazing sheet according to the present invention is used for plate materials, the thickness of the brazing sheets is preferably about 0.80 to 5.00 mm.

The aluminum alloy brazing sheet according to the present invention may be formed of the brazing material the surface of which is etched with acid.

By this etching, an aluminum oxide film or a MgO film formed on the surface can be weaken or removed in advance.

Details of this etching will be described later.

According to the present invention, it is possible to provide a brazing sheet having excellent brazability in brazing an aluminum material without using flux in an inert gas atmosphere such as nitrogen gas atmosphere.

The following describes a method for manufacturing an aluminum alloy brazing sheet according to the present invention.

This manufacturing method according to the present invention is a method for manufacturing the aluminum alloy brazing sheet according to the present invention, wherein in manufacturing the aluminum alloy brazing sheet by subjecting a laminate comprising a core-material ingot and a brazing-material ingot laminated on one side or both sides of the core-material ingot to at least hot working, cold working, and one or more annealings selected from one or more intermediate annealings between passes of rolling in the cold working and final annealing after the last pass of the cold working, heating during the one or more annealings selected from the intermediate annealings between the passes of the cold rolling and the final annealing after the last pass of the cold working is performed such that a value of a diffusion area D expressed by Formula (I) below becomes 7.0×10⁻¹⁰ m² or less,

$$D = Σ {D}_{0} \cdot exp ( - Q / ( RTn ) ) \cdot Δ tn \qquad ( I )$$

(in Formula, Tn is a heating temperature (K) at each infinitesimal time when the total heating time (in seconds) in the intermediate annealings and the final annealing is divided by an infinitesimal time Δtn (in seconds), D₀=1.24×10⁻⁴ (m²/s), Q=130 (kJ/mol), and R=8.3145 (J/(mol·K)).

In the method for manufacturing an aluminum alloy brazing sheet according to the present invention, the core-material ingot, the brazing-material ingot, and, if necessary, a sacrificial-anode-material ingot are prepared first by melting and casting aluminum alloys having desired chemical compositions of the core material, the brazing material, and, if necessary, the sacrificial anode material, respectively. The method of melting and casting them is not limited to a particular one, and a common method is used.

Subsequently, the core-material ingot, the brazing-material ingot, and, if necessary, the sacrificial-anode-material ingot are preferably homogenized, as appropriate. The preferred temperature range for this homogenization is 400 to 600° C., and the time for the homogenization is 2 to 20 hours.

Subsequently, the core-material ingot, the brazing-material ingot, and, if necessary, the sacrificial-anode-material ingot are formed in predetermined thicknesses by facing or hot rolling, and then the predetermined ingots are stacked in a predetermined order to form a laminate.

The core-material ingot, the brazing-material ingot, and, if necessary, the sacrificial-anode-material ingot respectively have compositions corresponding to the compositions of the core material, the brazing material, and the sacrificial anode material that constitute the aluminum alloy brazing sheet to be obtained.

In the method for manufacturing an aluminum alloy brazing sheet according to the present invention, the above-described laminate is subjected to at least hot working, cold working, and one or more annealings selected from one or more intermediate annealings between passes of rolling in the cold working and the final annealing after the last pass of the cold working.

In the hot working, the laminate formed by laminating the predetermined ingots in a predetermined order is hot rolled at 400 to 500° C. In the hot rolling, for example, rolling is performed until a sheet thickness of 2 to 8 mm is reached.

In the cold working, a hot-rolled product obtained by performing the hot working is cold rolled. In the cold working, cold rolling is performed in a plurality of passes.

In the cold working, one or two or more intermediate annealings between passes of the cold rolling are preferably performed such that the heating temperature becomes between 20° and 500° C., and more preferably performed such that it becomes between 25° and 400° C.

In each intermediate annealing, the temperature is raised to the intermediate annealing temperature, and cooling may be started immediately after the intermediate annealing temperature is reached, or cooling may be started after the intermediate annealing temperature is reached and then the resulting product is held at the intermediate annealing temperature for a certain time. The holding time at the intermediate annealing temperature is 0 to 10 hours, and preferably 1 to 5 hours.

After the cold rolling, the resulting cold-rolled product is subjected to the final annealing as appropriate.

The final annealing is preferably performed such that the heating temperature becomes between 300 to 500° C., and more preferably performed such that it becomes 350 to 450° C.

In the final annealing, the temperature is raised to the final annealing temperature, and cooling may be started immediately after the final annealing temperature is reached, or cooling may be started after the final annealing temperature is reached and then the resulting product is held at the final annealing temperature for a certain time. The holding time at the final annealing temperature is 0 to 10 hours, and preferably 1 to 5 hours.

Although the atmosphere during the intermediate annealing and the final annealing is not limited to a particular one, these annealings are preferably performed in an atmosphere having a lower oxygen concentration than that in the air. By heating in an atmosphere having a lower oxygen concentration than that in the air, the growth of an oxide film on the surface of the brazing material can be suppressed.

In the method for manufacturing an aluminum alloy brazing sheet according to the present invention, the intermediate annealings or the final annealing is preferably performed with the brazing-material ingot being rolled to a thickness of 10 μm to 50 μm, and more preferably performed with it being rolled to a thickness of 20 μm to 50 μm.

By controlling the thickness of the brazing-material ingot during the intermediate annealing or the final annealing within these ranges, the concentration of Mg diffusing from the core-material ingot to the surface of the brazing-material ingot can be reduced, and the formation and growth of a MgO film can be suppressed to easily achieve desired brazing properties.

In the method for manufacturing an aluminum alloy brazing sheet according to the present invention, heating during the one or more annealings selected from the intermediate annealings between the passes of the cold rolling and the final annealing after the last pass of the cold working is performed such that a value of a diffusion area D expressed by Formula (I) below becomes 7.0×10⁻¹⁰ m² or less,

$$D = Σ {D}_{0} \cdot exp ( - Q / ( RTn ) ) \cdot Δ tn \qquad ( I )$$

(in Formula, Tn is a heating temperature (K) at each infinitesimal time when the total heating time (in seconds) in the intermediate annealings and the final annealing is divided by an infinitesimal time Δtn (in seconds), D₀=1.24×10⁻⁴ (m²/s), Q=130 (kJ/mol), and R=8.3145 (J/(mol·K)).

In the method for manufacturing an aluminum alloy brazing sheet according to the present invention, the heatings in the intermediate annealings between the passes of the cold rolling and the final annealing after the last pass of the cold working are performed such that the value of the diffusion area D becomes 7.0×10⁻¹⁰ m² or less, preferably performed such that it becomes 5.0×10⁻¹⁰ m² or less, and more preferably performed such that it becomes 2.0×10⁻¹⁰ m² or less.

The lower limit of this diffusion area D is not limited to a particular value, but in general, the diffusion area D is preferably 1.0×10⁻¹⁶ m² or more.

When the heatings in the intermediate annealings between the passes of the cold rolling and the final annealing after the last pass of the cold working are performed such that the value of the diffusion area D becomes 7.0×10⁻¹⁰ m² or less, the diffusion area of Mg diffusing from the core-material ingot to the surface layer of the brazing-material ingot can be limited.

In the method for manufacturing an aluminum alloy brazing sheet according to the present invention, by the heatings in the intermediate annealings between the passes of the cold rolling and the final annealing after the last pass of the cold working, Mg comprised in the core material diffuses toward the brazing material surface layer, but the diffusion area thereof can be easily controlled by controlling the temperature and time during the intermediate annealings and the final annealing such that the diffusion area D determined by Formula (I) becomes 7.0×10⁻¹⁰ m² or less.

According to a common procedure, a suitable diffusion effect is considered to be obtained by controlling the temperature finally reached by the heatings and the time for which this temperature is kept.

However, as described above, the aluminum alloy brazing sheet obtained by the manufacturing method according to the present invention is controlled to be formed such that the Mg integration value from the brazing material surface to a depth of 30 nm becomes 150 atm %×nm or less. In order to control the Mg integration value to be a suitable value, the total amount of heat input in all processes during the intermediate annealings and the final annealing needs to be controlled appropriately. To satisfy this need, the diffusion area D determined by Formula (I) described above needs to be controlled to be 7.0×10⁻¹⁰ m² or less, preferably 5.0×10⁻¹⁰ m² or less, and more preferably 2.0×10⁻¹⁰ m² or less.

In the method for manufacturing an aluminum alloy brazing sheet according to the present invention, the surface of the brazing sheet may be etched with acid, if necessary.

By performing the etching, an oxide film of aluminum and a MgO film formed during heating during the hot rolling or during heatings between passes and after the last pass of the cold rolling can be weakened or removed.

The timing for performing the etching is not limited to a particular timing if it is until brazing is performed with the brazing sheet after the hot rolling.

For example, the etching may be applied to a clad sheet after the hot rolling, or the etching may be applied to a clad sheet in the middle of the cold rolling. The etching may also be applied after the intermediate annealing or the final annealing.

Furthermore, after the above-described final annealing is completed, the brazing sheet may be stored in a state of having an oxide film, and the etching may be applied just before brazing.

If this oxide film has been weakened or removed when brazing is performed, the brazability during brazing with the brazing sheet can be improved.

As described above, by applying the etching, it is possible to weaken or remove the MgO film formed on the brazing material surface, i.e., to reduce the Mg concentration on the brazing material surface.

For example, for a material having a thin sheet thickness, such as a fin material to be used for an automotive heat exchanger, the etching process may be set before the annealing process due to facility constraints. Even in such a case, the etching is effective in reducing the Mg concentration on the brazing material surface, and furthermore the oxide film can be weakened and brazability can be easily improved by making conditions in the subsequent annealing process more suitable.

As acids to be used for the etching the brazing sheet, for example, aqueous solutions of sulfuric acid, hydrochloric acid, nitric acid, phosphoric acid, hydrofluoric acid, and the like can be used. These acids may be used alone or in combination with two or more types. From the viewpoint of removing the oxide film more efficiently, it is preferable to use as acid a mixed aqueous solution comprising hydrofluoric acid and an acid other than hydrofluoric acid, and it is more preferable to use a mixed aqueous solution of hydrofluoric acid and sulfuric acid or a mixed aqueous solution of hydrofluoric acid and nitric acid.

The etching amount during the etching is preferably 0.05 to 2.00 g/m². By setting the etching amount to 0.05 g/m² or more, and more preferably 0.10 g/m² or more, the oxide film on the brazing sheet surface can be sufficiently removed and the brazability can be further improved.

From the viewpoint of improving the brazability of the brazing sheet, there is no upper limit of the amount of etching.

However, if the etching amount is excessively large, it may be difficult to obtain the effect of brazability improvement commensurate with the processing time. This problem can be easily avoided by setting the etching amount to 2.00 g/m² or less, and more preferably 0.50 g/m² or less.

In the method for manufacturing an aluminum alloy brazing sheet according to the present invention, the aluminum alloy brazing sheet can be obtained in this way. Details of the resulting aluminum alloy brazing sheet are described in detail in the description of the aluminum alloy brazing sheet according to the present invention.

According to the present invention, the brazing sheet having excellent brazability can be easily manufactured when an aluminum material is brazed without using flux in an inert gas atmosphere such as nitrogen gas atmosphere.

Examples are given below to specifically illustrate the present invention, but the present invention is not limited to Examples described below.

### EXAMPLES

### Example 1

(1) A core-material ingot and a plurality of brazing-material ingots having chemical compositions given in Table 1 were each prepared by continuous casting.

Subsequently, the core-material ingot was homogenized, and was then faced such that the sheet thickness of the core-material ingot was a predetermined thickness. Subsequently, the brazing-material ingots were hot rolled such that the sheet thickness of the brazing-material ingots was a predetermined thickness.

The core-material ingot and the brazing-material ingots thus obtained were stacked in the order of a brazing-material-1 ingot/the core-material ingot/a brazing-material-2 ingot to obtain a laminate having a three-layer structure with the brazing-material-1 ingot and the brazing-material-2 ingot each stacked on both sides of the core-material ingot.

The laminate thus obtained was hot rolled to join the core-material ingot and the brazing-material ingots, whereby a clad material having a sheet thickness of 2.6 mm was prepared.

(2) The clad material obtained in (1) was cold rolled to obtain a cold-rolled product having a thickness of 0.17 mm.

Subsequently, the cold-rolled product thus obtained was subjected to intermediate annealing of heating in an air atmosphere, with the heating temperature and the heating time being controlled such that the value of a diffusion area D expressed by Formula (I) below became 1.0×10⁻¹⁰ m²,

$$D = Σ {D}_{0} \cdot exp ( - Q / ( RTn ) ) \cdot Δ tn \qquad ( I )$$

(in Formula, Tn is a heating temperature (K) at each infinitesimal time when the total heating time (in seconds) in the intermediate annealings and the final annealing is divided by an infinitesimal time Δtn (in seconds), D₀=1.24×10⁻⁴ (m²/s), Q=130 (kJ/mol), and R=8.3145 (J/(mol·K)).

The intermediate annealed product thus obtained was cold rolled to obtain a test material of the aluminum alloy brazing sheet having a thickness of 0.10 mm and having a three-layer structure with the brazing material 1/the core material/the brazing material 2, in which the respective clad ratios of the brazing materials on both sides of the core material were 12.6% (brazing material 1) and 11.3% (brazing material 2).

Conditions for preparing test materials described above are given in Table 3.

The Mg integration value from the surface of the brazing material 1 to a depth of 30 nm in each obtained test material was measured with an X-ray photoelectron spectrometer (XPS, PHI 5000 VersaProbe III manufactured by ULVAC-PHI, Inc.). Results are given in Table 4.

The thickness of an oxide film on the surface of the brazing material 1 of the obtained test material was measured by an X-ray photoelectron spectroscopy (XPS). In this case, oxygen (O) in the depth direction was measured for the brazing material surface of each test material, and the half-width of this measurement was determined as the thickness of the oxide film. Results are given in Table 4.

### <Brazability Evaluation>

Using the obtained test material, a mini-core test piece imitating a core of a corrugated-fin type heat exchanger was prepared by the following method, and brazability was evaluated based on the adhesion ratio of a fin.

In this evaluation, to begin with, as illustrated in FIG. 2, a mini-core test piece having: a corrugated fin 1 formed of a brazing sheet having brazing materials on both sides of the test material obtained in each of Examples and Comparative Example; and two flat plates 2, 2 between which the corrugated fin 1 was sandwiched was prepared.

Specifically, the obtained test material was cut into predetermined dimensions and then corrugated to obtain a corrugated fin 1-1 having a length of 35 mm, a height of 3 mm, and a pitch of 4.5 mm between peaks.

A JIS A3003 alloy sheet material was cut to obtain two flat plates 1-2 having a length of 35 mm, a width of 30 mm, and a plate thickness of 1.0 mm.

The corrugated fin 1 and the two flat plates 2, 2 were degreased with acetone, and then the corrugated fin 1 was sandwiched between the two flat plates 2, 2 to form an assembly.

The assembly thus obtained was heated to 600° C. in an inert gas atmosphere under heating conditions that required 3 minutes to reach 400° C. from 150° C. and 5 minutes to reach 600° C. from 400° C.

A temperature of 600° C. was then kept for 3 minutes to melt the brazing material, and the corrugated fin comprising the core material was brazed to the flat plates. The brazing atmosphere had a dew point of −60° C. and an oxygen concentration of 1 ppm.

The corrugated fin 1 was cut off from the mini-core test piece after the above-described heating, and the joining ratio was calculated by the following method based on traces of fillets present on the two flat plates 2, 2.

To begin with, the lengths of the traces of fillets individually present on the two plates 2, 2 were measured in a width direction d of each plate 2, and a sum L1 of these lengths was calculated. In addition to this, a total length L0 in the width direction d of the flat plate 2 was calculated for each fillet, on the assumption that the two flat plates 2, 2 and the corrugated fin 1 were completely joined. The ratio of the value of the length L1 to the length L0 was then calculated as a joining ratio (%).

The length L0 can be calculated, for example, by multiplying the width of the corrugated fin 1 (the length of the flat plate 2 in the width direction) by the number of peaks of the corrugated fin 1-2.

It should be noted in Examples herein that, to eliminate variations in the adhesion ratio due to poor assembly, two portions at the ends in the width direction (two portions at both ends indicated by the dashed lines in the example illustrated in FIG. 2) were excluded from the calculation of the joining ratio.

Based on the obtained joining ratio, brazability was evaluated by determining the brazability to be excellent (∘) if the joining ratio was 60% or more, and by determining the brazability to be poor (×) if the joining ratio was less than 60%. Results are given in Table 4.

### Example 2

The same processes as in Example 1 were performed except that the heating temperature and the heating time during the intermediate annealing were controlled such that the diffusion area D became 2.7×10⁻¹⁰ m², and a test material of the aluminum alloy brazing sheet having a thickness of 0.10 mm and having a three-layer structure with the brazing material 1/the core material/the brazing material 2 was obtained, in which the respective clad ratios of the brazing materials formed on both sides of the core material were 12.6% (brazing material 1) and 11.3% (brazing material 2).

The test material thus obtained was used and evaluated in the same manner as in Example 1. Results are given in Table 4.

### Example 3

The same processes as in Example 1 were performed except that the heating temperature and the heating time during the intermediate annealing were controlled such that the diffusion area D became 6.7×10⁻¹⁰ m², and a test material of the aluminum alloy brazing sheet having a thickness of 0.10 mm and having a three-layer structure with the brazing material 1/the core material/the brazing material 2 was obtained, in which the respective clad ratios of the brazing materials formed on both sides of the core material were 12.6% (brazing material 1) and 11.3% (brazing material 2).

The test material thus obtained was used and evaluated in the same manner as in Example 1. Results are given in Table 4.

### Comparative Example 1

The same processes as in Example 1 were performed except that the heating temperature and the heating time during the intermediate annealing were controlled such that the diffusion area D became 13.5×10⁻¹⁰ m², and a test material of the aluminum alloy brazing sheet having a thickness of 0.10 mm and having a three-layer structure with the brazing material 1/the core material/the brazing material 2 was obtained, in which the respective clad ratios of the brazing materials formed on both sides of the core material were 12.6% (brazing material 1) and 11.3% (brazing material 2).

The test material thus obtained was used and evaluated in the same manner as in Example 1. Results are given in Table 4.

### Example 4

(1) A clad material having a sheet thickness of 2.6 mm was prepared by the same method as in Example 1 (1).
(2) The clad material obtained in (1) was cold rolled to obtain a cold-rolled product having a thickness of 0.30 mm, and this obtained cold-rolled product was etched with an etching solution (comprising hydrofluoric acid at 0.1% and sulfuric acid at 1.0%) at 70° C.

The etched product thus obtained was then further cold rolled to obtain a cold-rolled product having a thickness of 0.17 mm.

Subsequently, the cold-rolled product thus obtained was subjected to intermediate annealing of heating in an atmosphere in which the oxygen concentration was controlled to be 0.2 vol % or less, with the heating temperature and the heating time being controlled such that the value of a diffusion area D expressed by Formula (I) below became 1.0×10⁻¹⁰ m²,

$$D = Σ {D}_{0} \cdot exp ( - Q / ( RTn ) ) \cdot Δ tn \qquad ( I )$$

(in Formula, Tn is a heating temperature (K) at each infinitesimal time when the total heating time (in seconds) in the intermediate annealings and the final annealing is divided by an infinitesimal time Δtn (in seconds), D₀=1.24×10⁻⁴ (m²/s), Q=130 (kJ/mol), and R=8.3145 (J/(mol·K)).

The intermediate annealed product thus obtained was cold rolled to obtain a test material of the aluminum alloy brazing sheet having a thickness of 0.10 mm and having a three-layer structure with the brazing material 1/the core material/the brazing material 2, in which the respective clad ratios of the brazing materials on both sides of the core material were 12.6% (brazing material 1) and 11.3% (brazing material 2).

The test material thus obtained was used and evaluated in the same manner as in Example 1. Results are given in Table 4.

### Example 5

The same processes as in Example 1 were performed except that a core-material ingot, a brazing-material-1 ingot, and a brazing-material-2 ingot, prepared by continuous casting and each having the chemical composition given in Table 2, were used and the atmosphere during intermediate annealing was changed to an atmosphere in which the oxygen concentration was controlled to 0.2 vol % or less. A test material of the aluminum alloy brazing sheet having a thickness of 0.10 mm and having a three-layer structure with the brazing material 1/the core material/the brazing material 2 was obtained, in which the respective clad ratios of the brazing materials on both sides of the core material were 11.9% (brazing material 1) and 12.1% (brazing material 2).

The test material thus obtained was used and evaluated in the same manner as in Example 1. Results are given in Table 4.

TABLE 1
<Examples 1 to 4, Comparative Example 1>

| | Si | Fe | Cu | Mn | Mg | Zn | Ti | Bi | Al |
|---|---|---|---|---|---|---|---|---|---|
| Brazing- | 9.50 | 0.26 | — | — | — | — | — | 0.008 | Bal.* |
| material-1 | | | | | | | | | |
| ingot | | | | | | | | | |
| Brazing- | | | | | | | | | |
| material-2 | | | | | | | | | |
| ingot | | | | | | | | | |
| Core- | 0.40 | 0.20 | 0.18 | 1.10 | 0.15 | 1.60 | — | — | Bal.* |
| material | | | | | | | | | |
| ingot | | | | | | | | | |

(Unit: mass %)
*“Bal.” in the Table means the balance.

TABLE 2
<Example 5>

| | Si | Fe | Cu | Mn | Mg | Zn | Ti | Bi | Al |
|---|---|---|---|---|---|---|---|---|---|
| Brazing- | 9.40 | 0.22 | — | — | — | — | — | 0.008 | Bal.* |
| material-1 | | | | | | | | | |
| ingot | | | | | | | | | |
| Brazing- | | | | | | | | | |
| material-2 | | | | | | | | | |
| ingot | | | | | | | | | |
| Core- | 0.40 | 0.18 | 0.17 | 1.11 | 0.15 | 1.60 | — | — | Bal.* |
| material | | | | | | | | | |
| ingot | | | | | | | | | |

(Unit: mass %)
*“Bal.” in the Table means the balance.

TABLE 3

| | | | | Sheet | | |
|---|---|---|---|---|---|---|
| | | | | thickness | Diffusion | |
| | Clad ratio (%) | | | (mm) | area (m²) | Atmosphere |
| | Brazing | Brazing | | during | during | during |
| | material 1 | material 2 | Etching | etching | annealing | annealing |
| Example 1 | 12.6 | 11.3 | None | — | 1.0 × 10⁻¹⁰ | Air |
| Example 2 | 12.6 | 11.3 | None | — | 2.7 × 10⁻¹⁰ | Air |
| Example 3 | 12.6 | 11.3 | None | — | 6.7 × 10⁻¹⁰ | Air |
| Comparative | 12.6 | 11.3 | None | — | 13.5 × 10⁻¹⁰ | Air |
| Example 1 | | | | | | |
| Example 4 | 12.6 | 11.3 | Performed | 0.30 | 1.0 × 10⁻¹⁰ | Controlled* |
| Example 5 | 11.9 | 12.1 | None | — | 1.0 × 10⁻¹⁰ | Controlled* |

*“Controlled” in the Table means that the concentration of oxygen was controlled to be 0.2 vol % or less.

TABLE 4

| | Mg integration | | | |
|---|---|---|---|---|
| | value (atm % × | Oxide film | Joining | Brazability |
| | nm) | thickness (nm) | ratio (%) | evaluation |
| Example 1 | 54 | 12.3 | 94 | ◯ |
| Example 2 | 69 | 16.0 | 76 | ◯ |
| Example 3 | 126 | 16.6 | 67 | ◯ |
| Comparative | 195 | 19.4 | 56 | X |
| Example 1 | | | | |
| Example 4 | 43 | 6.6 | 75 | ◯ |
| Example 5 | 39 | 9.2 | 91 | ◯ |

It can be seen from Table 4 that the test materials of the aluminum alloy brazing sheets obtained in Examples 1 to 5 were all rated as “∘” when brazability was evaluated and all exhibited excellent brazability (joining performance), in each of which the core material was made of an aluminum alloy comprising Mg at 0.10 to 0.50 mass % with the balance being aluminum and inevitable impurities, the brazing material was made of an aluminum alloy comprising Si at 6.00 to 13.00 mass % and Mg at a content limited to less than 0.05 mass % with the balance being aluminum and inevitable impurities, and the Mg integration value from a surface of the brazing material to a depth of 30 nm was 150 atm %×nm or less.

By contrast, it can be seen from Table 4 that the test material of the aluminum alloy brazing sheet obtained in Comparative Example 1 was rated as “×” when brazability was evaluated and exhibited poor brazability (joining performance), in which the Mg integration value from a surface of the brazing material to a depth of 30 nm was 195 atm %×nm, which was high.

### INDUSTRIAL APPLICABILITY

According to the present invention, it is possible to provide a brazing sheet having excellent brazability in brazing an aluminum material without using flux in an inert gas atmosphere such as nitrogen gas atmosphere, and a method for manufacturing the same.

1.-7. (canceled)

8. An aluminum alloy brazing sheet to be used for brazing in an inert gas atmosphere, the aluminum alloy brazing sheet comprising:
a core material; and
a brazing material clad on one side or both sides of the core material, wherein
the core material is made of an aluminum alloy comprising Mg at 0.10 to 0.50 mass %, optionally comprising Zn at 3.00 mass % or less, one type or two or more types of: Fe at 0.70 mass % or less; Si at 0.70 mass % or less; Mn at 1.60 mass % or less; and Cu at 0.50 mass % or less, with the balance being aluminum and inevitable impurities,
the brazing material is made of an aluminum alloy comprising Si at 6.00 to 13.00 mass % and Mg at a content limited to less than 0.05 mass %, optionally Bi at 1.00 mass % or less, with the balance being aluminum and inevitable impurities, and
a Mg integration value from a surface of the brazing material to a depth of 30 nm is 150 atm %×nm or less.

9. The aluminum alloy brazing sheet according to claim 8, wherein the surface is etched with acid.

10. A method for manufacturing the aluminum alloy brazing sheet according to claim 8, wherein
in manufacturing the aluminum alloy brazing sheet by subjecting a laminate comprising a core-material ingot and a brazing-material ingot laminated on one side or both sides of the core-material ingot to at least hot working, cold working, and one or more annealings selected from one or more intermediate annealings between passes of rolling in the cold working and final annealing after a last pass of the cold working,
heating during the one or more annealings selected from the intermediate annealings between the passes of the cold rolling and the final annealing after the last pass of the cold working is performed such that a value of a diffusion area D expressed by Formula (I) below becomes 7.0×10⁻¹⁰ m² or less,
$$D = {ΣD}_{0} \cdot exp ( - Q / ( RTn ) ) \cdot Δ tn \qquad ( I )$$
(in Formula, Tn is a heating temperature (K) at each infinitesimal time when a total heating time (in seconds) in the intermediate annealings and the final annealing is divided by an infinitesimal time Δtn (in seconds), D₀=1.24×10⁻⁴ (m²/s), Q=130 (kJ/mol), and R=8.3145 (J/(mol·K)).

11. The method for manufacturing the aluminum alloy brazing sheet according to claim 10, wherein the intermediate annealings or the final annealing is performed with the brazing-material ingot being rolled to a thickness of 10 μm to 50 μm.
